(19) United States
(12) Patent Application Publication
(10) Pub. No.: US 2026/0365137 A1
(43) Pub. Date: Nov. 19, 2026

(54) SEAT BELT RETRACTOR WITH ADAPTIVE LOAD LIMITING AND FINE POSITION EXTENSION STOP

(71) Applicant: AUTOLIV ASP, INC., Ogden, UT (US)

(72) Inventors: Bin WANG, Lake Orion, MI (US); Jon E. BURROW, Ortonville, MI (US); Christopher D. HALL, Algonac, MI (US)

(73) Assignee: AUTOLIV ASP, INC., Ogden, UT (US)

(21) Appl. No.: 19/209,015

(22) Filed: May 15, 2025

(51) Int. Cl. B60R 22/34; B60R 22/28

(52) U.S. Cl. CPC B60R 22/3413; B60R 22/28; B60R 2022/287

(57) ABSTRACT

A seat belt retractor spool for a retractor providing load limiting and protraction stop functions. The spool assembly is formed from a number of interfitting components which provide multiple torque transmitting interfaces. At least one of the interfaces is formed by components which are press fit together which enables an infinite adjustment of their relative angular orientation as they are assembled. For retractors providing load limiting with a webbing extension stop feature, the assembly permits a precise setting of the webbing extension from the spool in a load limiting retractor operation sequence. Methods of assembling a spool assembly having these features are also described.

### FIELD OF THE INVENTION

The present invention is related to a motor vehicle seat belt retractor mechanism and particularly to a spool assembly for a retractor featuring adaptive load limiting and protraction stop functions with features providing fine adjustment of the webbing stop position.

### BACKGROUND

Modern motor vehicles incorporate occupant restraint systems including seat belt systems and frequently inflatable restraint systems. Significant improvements have been made in the design of seat belt retractor systems. A seat belt retractor generally incorporates a spindle or spool to which a seat belt webbing is attached at one end and around which the webbing is wound. The spool has an associated retraction spring enabling the spool to rotate to take up slack in the seat belt and maintain the seat belt in a stowed condition when not in use. Seat belts can be drawn out from the retractor at a relatively low rate to allow an occupant to fasten the seat belt. An associated blocking mechanism locks the spool to control webbing paying out (protraction) in an impact or rollover condition. However, in such an impact condition, particularly in a high energy impact, the seat belt can impose severe loads on the occupant in the course of restraining the occupant. Accordingly, modern seatbelt retractors often incorporate some type of load limiting function to limit the force applied by the seat belt to the occupant in the event of a vehicle impact. For retractors, such a load limiting device may incorporate a torsion bar coupled to the spool and arranged as to torsionally deform when a predetermined torque is applied to the spool by seat belt tension such that the spool rotates, paying out a limited length of seat belt webbing to reduce the restraint loads acting on the occupant.

A further enhancement feature may be incorporated into retractors with adaptive load limiting functions in the form of a stop or stopper function which limits webbing protraction in load limiting operation conditions. A positive stop can be used to provide better protection for occupants in real world collisions, for example, large occupants, severe crashes or rollovers. One configuration of an extension stop is the provision of an externally threaded post or collar affixed to a spool component with an installed threaded stop nut. Relative rotation between the spool and a fixed section of the retractor frame while the torsion bar deforms causes the nut to advance along the threaded section until it reaches a fully threaded position where it grounds out against a shoulder of the post, locking the spool and restricting further webbing protraction. This limits of the total deformation of the torsion bar which may be desirable for tailoring retractor restraint characteristics.

Examples of seat belt retractor designs having some or all of the above described features are provided by reference to US 2011/0000996 A1, US 8,231,073 B2 and WO 2020/021003 A1, owned by the present applicant and which are hereby incorporated into this disclosure by reference.

Increasingly stringent governmental regulations and automotive vehicle manufacturer specifications impose additional requirements concerning the retractor stop function. For example, it may be necessary or desirable to precisely establish the length of webbing which is drawn from the retractor when the stop function engages. One configuration of a retractor spool stop function uses a stop nut, described briefly above having a hexagonal outer surface which is received by a mating hexagonal internal surface formed at one end of the retractor spool. The current design torsion bar typically incorporates opposing ends which are star shaped with six protrusions (similar to "Torx" type fastener heads), which are received in mating shaped pockets of the retractor spool at one end and at the opposite end into an insert of the stopper assembly. The provision of six protrusions (in one example) limits the degree of accuracy for the stop function since the six protrusions results in a 60° separation between indexable assembled positions, which translates to significant steps in setting the webbing extension when the stop engages.

Certain design alternatives can be considered for addressing the shortcomings of the present design concerning fine adjustment of stop position. For example, for current designs utilizing a hexagonal stop nut, an assembly sequence can be envisioned in which the torsion bar can be pre-twisted in a manner that produces a fine adjustment of stop position, even keeping with the limits of a hexagonal interface. However, this could lead to a changing of the torsion bar material characteristics leading to variations in torsion bar deformation behavior during load limiting restraint. Another countermeasure could be providing a torsion bar or stop nut having an end with a greater number of protruding lugs, for example twelve, reducing the angular separation between assembled positions. However, going to a torsion bar having twelve possible installed rotational positions does improve on the current design but would only reduce variability to about 15°. A torsion bar and interfitting components with a greater number of protruding lugs or teeth face limitations concerning component manufacturability and assembly.

This invention is related to a seat belt retractor with a stop function having provisions for fine adjustment of setting of the stop function such that the stop function engages when a precise length of the webbing is withdrawn during a load limiting operation, not limited to stepwise increments.

### SUMMARY

In accordance with the present invention, adjustment of the angular position of the torsion bar relative to the stop nut and insert is established by creating an interference fit at one or more interfaces between the spool, the torsion bar, the insert and the tread head. No longer is the rotational orientation established in a fixed manner by the component configurations. Here, an infinite number of angular orientations is established by the provision of one or more an interference fits at torque transmitting interfaces. An assembly process is described for establishing the relationship between the components using such interference fit connections. The components can be preset to a desired configuration and then press fit into their final position.

### BRIEF DESCRIPTION OF THE DRAWINGS

Exemplary embodiments of the present invention will be described with reference to the appended drawing figures summarized as follows:

FIG. 1 is an exploded pictorial view of an example seat belt spool assembly in accordance with the prior art.

FIG. 2 is a partial exploded pictorial view of a spool and stop nut variation of the components shown in FIG. 1.

FIG. 3 is and exploded pictorial view of a spool assembly in accordance with the present invention.

FIG. 4 is an exploded cut-away view enlargement of the connection between the torsion bar and insert, and the stop nut and spool.

FIG. 5 is a pictorial view showing the interaction between the torsion bar and spool end pocket.

FIG. 6 is a cross-sectional and pictorial view showing a first alternate embodiment of an interface between the torsion bar and the spool blind end pocket.

FIGS. 7-9 illustrate a second alternate embodiment of the spool assembly.

FIG. 10 is an exploded pictorial view of a third alternate embodiment of the present invention.

FIG. 11 is a pictorial view of an alternate embodiment of a spline connection in accordance with the present invention.

FIG. 12 is a cross-sectional view showing the spline connection of the alternate embodiment shown in FIG. 11.

### DETAILED DESCRIPTION OF EXEMPLARY EMBODIMENTS OF THE PRESENT INVENTION

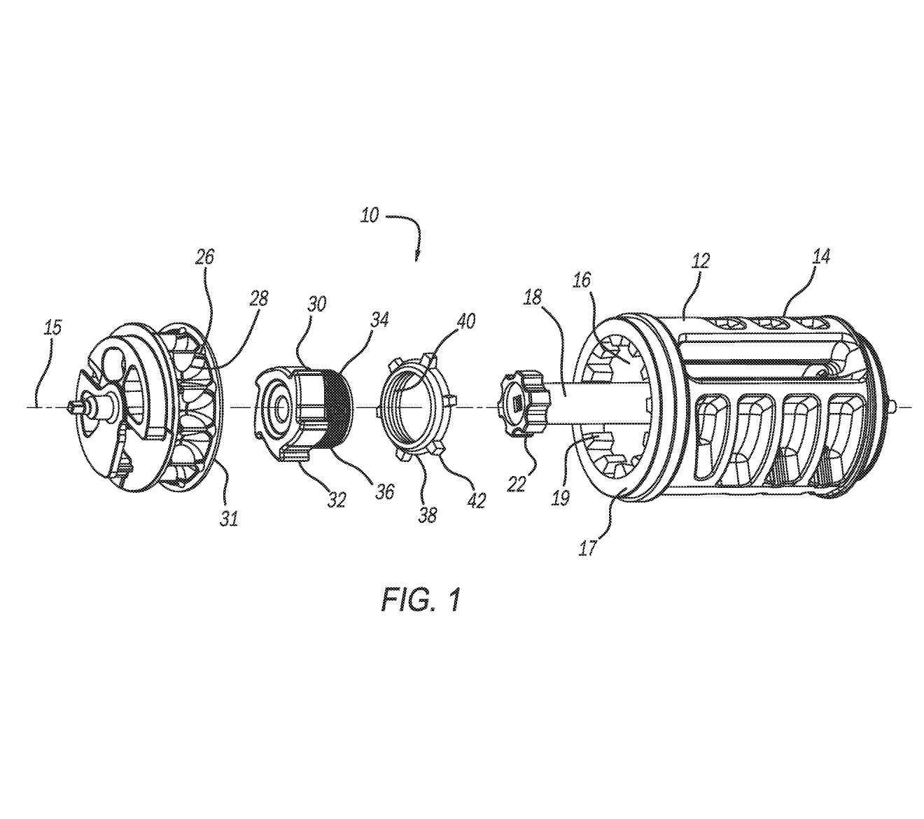

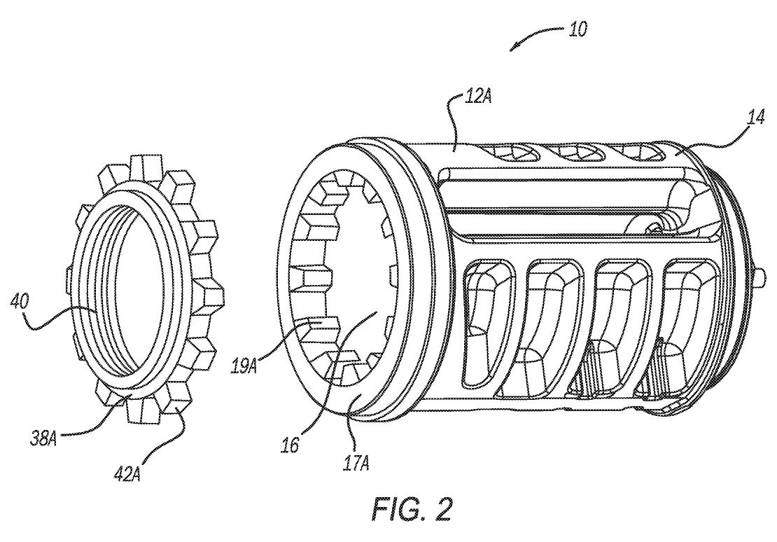

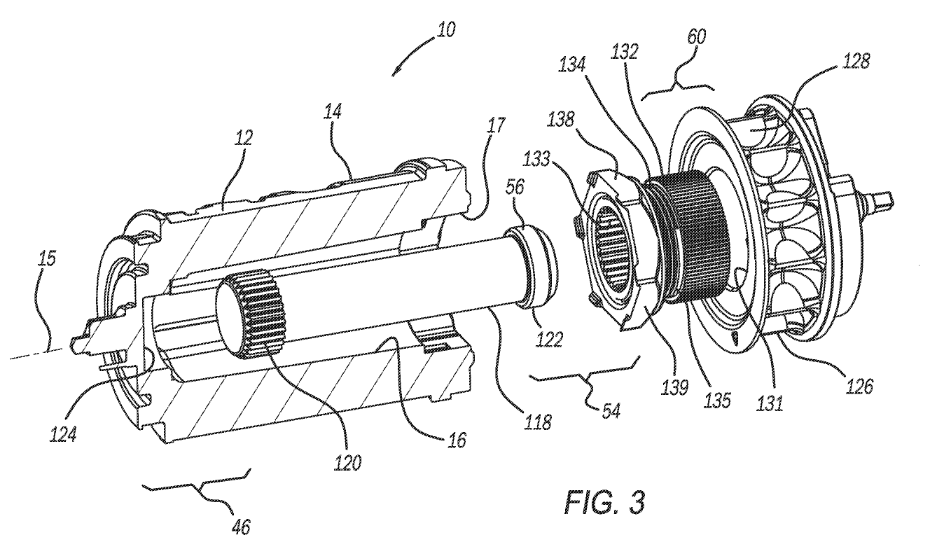

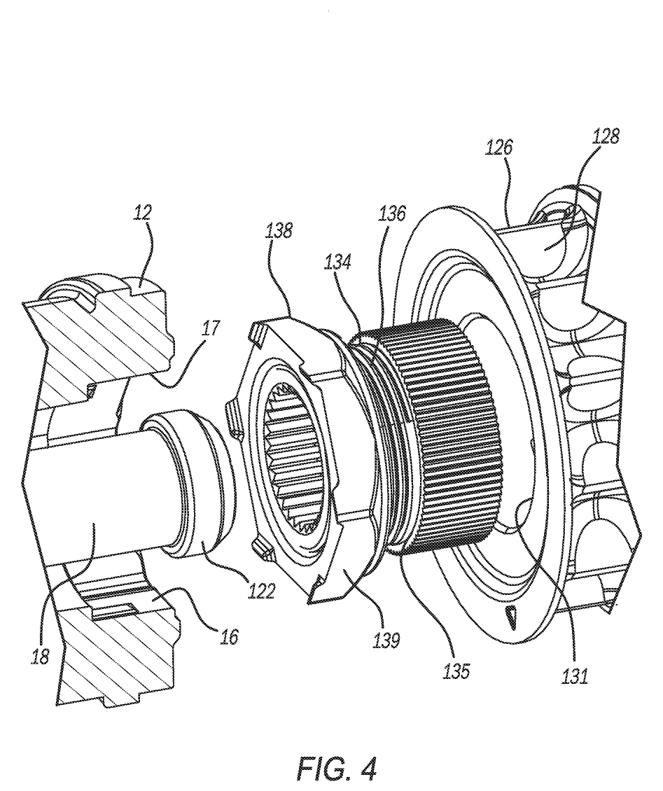

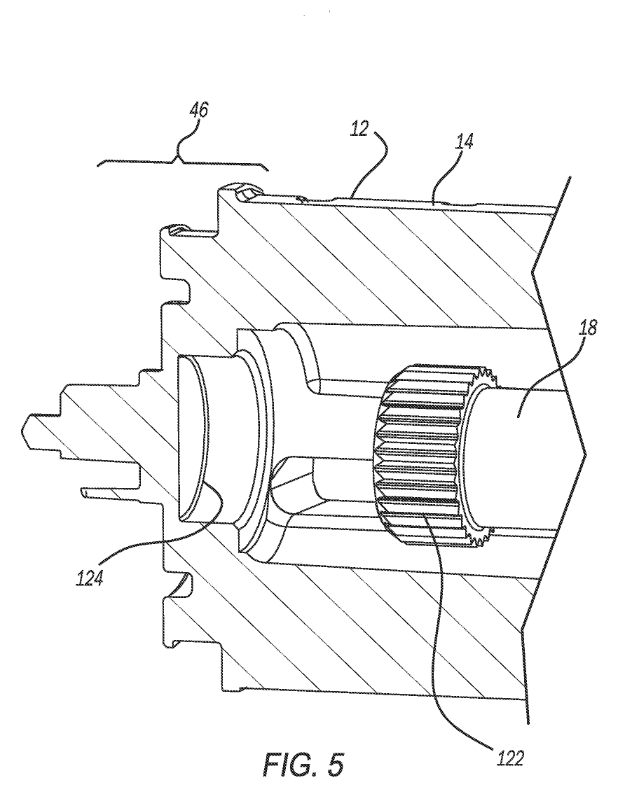

Embodiments of the present invention will be described with reference to FIGS. 1-12, with FIGS. 1 and 2 showing a prior art design configurations, and FIGS. 3-12 showing alternative embodiments of designs providing the desired design configuration in accordance with embodiments of the present invention.

FIGS. 1 and 2 illustrate an exemplary spool assembly 10 in accordance with the prior art incorporating a load limiting function showing components provided for a load limiting stop function. Spool 12 of spool assembly 10 has a generally cylindrical form centered and rotatable along longitudinal axis 15 with an external surface 14 (skeletonized to reduce mass) adapted for attachment to one end of a seat belt webbing (not shown) and enabling multiple wraps of the webbing to be a wound onto the outer surface for storing the webbing. Spool 12 further forms open end surface 17 opening into interior cavity 16 which receives torsion bar 18 having first and second ends 20 (hidden inside spool 12) and 22. Open end surface 17 forms an annular surface with radially inward extending teeth 19.

Spool 12 interior cavity 16 forms blind end pocket 24 (hidden inside spool 12 in FIG. 1) which receives torsion bar first end 20.

Tread head 26 is provided which interacts with belt webbing control functions which are well known in the prior art, including, for example, for providing an inertial locking or “vehicle sensitive” response. External pockets 28 are provided as a part of a pyrotechnic roto-pretensioning feature also well known in the prior art and outside the scope of distinguishing features of the present invention. Tread head 26 forms an internal pocket 31 (not shown in FIG. 1) which interacts with insert component 30. Insert 30 forms an external toothed surface 32 which is engageable with tread head cavity 31. Insert 30 further forms a protruding tubular section 34 forming external threads 36 and an internal surface 33 which receives torsion bar second end 22.

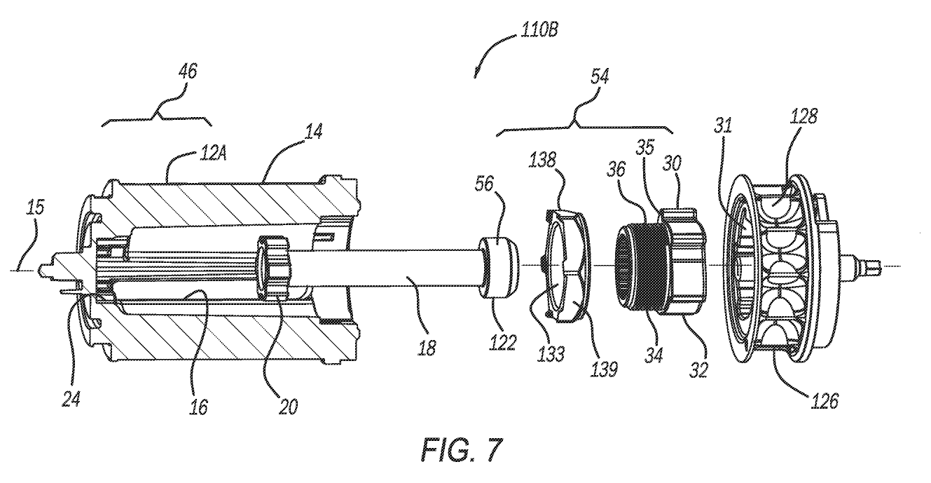

Hex nut 38 forms an internal threaded surface 40 which meshes with insert external threads 36. Hex nut 38 further forms radially outward protruding teeth 42. Hex nut 38 is adapted to be received into spool open end surface 17 with teeth 42 engaging with teeth 19. Hex nut 38 can be threaded onto insert external threads 36 until hex nut 38 bottoms out by engagement with stop shoulder 35 (shown in FIG. 7).

Torsion bar second end 22 has a toothed or “star” configuration and is received into insert internal surface 33. Likewise torsion bar first end 20 is received into spool blind end pocket 24 (not shown). The components illustrated in FIG. 1 are assembled by collapsing them together from their positions shown along axis 15.

Insert 30 and hex nut 38 provide a webbing extension limiting function. During a restraint event, tread head 26 is locked relative to a retractor frame (not shown). If sufficient tension is applied by the seat belt webbing onto spool 12, torsional deformation of torsion bar 18 occurs which serves to limit loads applied to the webbing for enhanced restraint performance, as described previously. During such torsion bar deformation, hex nut 38 is caused to advance along insert external threads 36 and if sufficient torsion bar rotation occurs, hex nut 38 will ground out against stop shoulder surface 35 of insert 30, causing the spool 12 to be locked through tread head 26 to the retractor frame, thus providing the extension stop feature.

During the assembly sequence for the prior art spool assembly 10, hex nut 38 can be installed onto insert 30 and turned until the nut bottoms out on the insert. Next, hex nut 38 can be backed off to a predetermined angle or number of rotations (e.g. a total of 480° of rotation) then the nut can be inserted into the spool internal surface. As is evident by reference to FIG. 1, the fineness or accuracy of the relative positioning between the spool 12 and hex nut 38 is limited by the fineness of the teeth 42. One manner of increasing the fineness of adjustment is to provide a greater number of discrete positions for hex nut 38A and spool 12A by making the teeth 42A having a finer pitch and fitting into spool open end 17A as shown by the example shown in FIG. 2. However, there are limitations in further increases of the number and fineness of these teeth in this interface due to a manufacturability and material characteristics of the components. In either of the designs shown in FIGS. 1 and 2, hex nut teeth 42 or 42A can mesh with spool open end surface 17 or 17A in only a set number of relative angular orientations as determined by the number of teeth present. Thus, there are only a limited number of discrete rotational indexed or clocked orientations that hex nut 38 or 38A can fit into spool open end 17. Likewise the other mating components of spool assembly 10 have set angular or clocked relative orientations once assembled. Accordingly, the accuracy of the webbing extension length established by spool assembly 10 is limited. The present invention seeks to overcome this limitation and provide much greater accuracy in setting the webbing extension stop position. By more accurately establishing the positive stop position, retractor performance can be better optimized.

A spool assembly in accordance with the present invention is shown by FIGS. 3-12. Components of spool assembly 110 having configurations and characteristics similar to those previously described for the prior art designs are identified by the reference numbers previously used with 100 added. In this example, a number of torque transmitting interfaces are identified. In this description, a “torque transmitting interface” describes an assembled connection between two mating components capable of transferring rotation and torque through the connection. A first torque transmitting interface 46 is formed by the interaction of torsion bar first end 120 which in this case has a knurled or splined configuration and is received by spool blind end pocket 124. First end 120 and blind end pocket 124 are dimensioned to provide an interference fit. Since blind end pocket 124 has a smooth cylindrical surface, any number of discrete angular orientations can be provided in the fit of first end 120 into blind end pocket 124. In this description an “interference” (or “press”) fit is intended to encompass any assembly between two components which require elastic and/or plastic deformation of one of the components during an assembly sequence which provides unlimited relative angular positions between the components once assembled. An interference fit as described herein can be enhanced by having one of the components formed with a toothed or splined configuration which will deform another mating component having a relatively smooth engaging surface. The interference fits described herein are intended to create a permanent connection between components and are not suited for convenient disassembly and reassembly. In this description, the terms “knurled”, “splined” or “toothed” are used interchangeably to encompass any surface contour providing a pattern of localized protrusions which serve to enhance torsional coupling after an interference fit is formed at any of the torque transmitting interfaces. Where surfaces are described as smooth, the term is intended to encompass a surface which lacks patterned protrusions.

A second torque transmitting interface 54 is established by the interaction between torsion bar second end 122 and insert internal surface 133. In this case, torsion bar second end 122 forms a smooth, ring-shaped external surface 56 which is received in an interference fit manner with splined internal nut surface 133. A third torque transmitting interface is defined by the interaction between insert external surface 132 and tread head interior cavity 131. In a manner similar to the first and second torque transmitting interfaces, an interference fit is provided between surface 132 and interior cavity 131. Moreover, like the prior interfaces, this third torque transmitting interface also permits an infinite adjustment of the relative angular position for installation of insert 130 into tread head 126.

In the embodiment illustrated in FIG. 3, hex nut 138 features a hexagonal outer surface 139 which is received in a mating fashion by spool open end 117. This configuration differs from that shown in FIGS. 1 and 2 showing a gear shaped outer surface shape. This configuration however has the same limitations as the example shown by the prior figures in providing only limited discrete angular relative orientations for assembly. This interaction is another torque transmitting interface but does not have features for infinite relative angle assembled conditions. As explained further, it is not necessary for each of the torque transmitting interfaces of spool assemble 110 to provide such capabilities.

In the above description, each of the first, second and third torque transmitting interfaces are described in a manner which provides infinite relative angle or clocking positioning between their interfacing components. The advantages of the present invention can be achieved utilizing only one or more of these torque transmitting features with infinite adjustment capabilities. For example, the first interface 46 between torsion bar first end 120 and blind end pocket 124 can be consistent with the prior art description described previously. The second torque transmitting interface 54 could be provided in the manner previously described with the interaction described in the prior art example. And further, the third torque transmitting interface 60 between insert 130 and the tread head internal surface 131 could also be hex-shaped or some other form that provides torque transmission capabilities but with a predetermined indexed discrete angular positions. It is only necessary for one of the torque transmitting interfaces to have the press fit features of the present invention.

Another aspect of the present invention is that the interfaces at the first, second and third torque transmitting interfaces 46, 54 and 60 do not have to be formed by one component having a smooth surface and another having a toothed, knurled or splined configuration. Depending on performance requirements, smooth shaped interfacing features could be used which provide sufficient torque transmitting capabilities due to their interference fit. For example, torsion bar first end 120, hex nut internal surface 133 and/or insert surface 132 could be made smooth. The provision of knurled or splined surfaces may provide improved torque transmission capabilities and may facilitate component assembly. For the interface configurations having knurls or splines it is preferable to have the knurls on the component made from the hardest material, for example on a heat treated hardened insert 130. With these designs there is no spline alignment requirement and therefore any angular orientations can be a set at any one of the torque transmitting interfaces which allows exact adjustment of stop nut 138 to a desired predetermined us set up angle.

A further refinement of the torque transmitting interfaces is to provide one of the components with a leading relief angle, for example providing the knurl with a reduced height at one end. This can allow for reduced assembly force requirements.

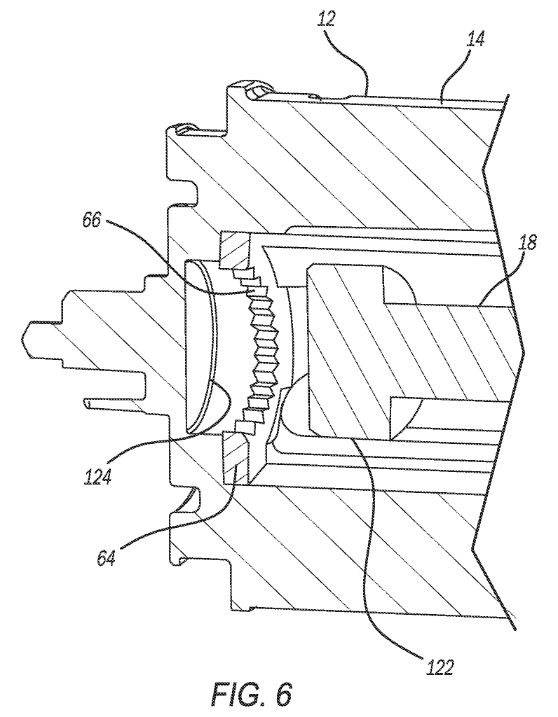

A first alternate embodiment of the present invention is illustrated by FIG. 6. In this example, torsion bar second end 122 features a smooth outer cylindrical surface. A hardened metal insert 64 with internal teeth 66 is pressed into spool blind end pocket 124. When these parts are assembled, insert 64 deforms the outer surface of the torsion bar first end 120 to create the desired interference fit with high torque transmission capabilities.

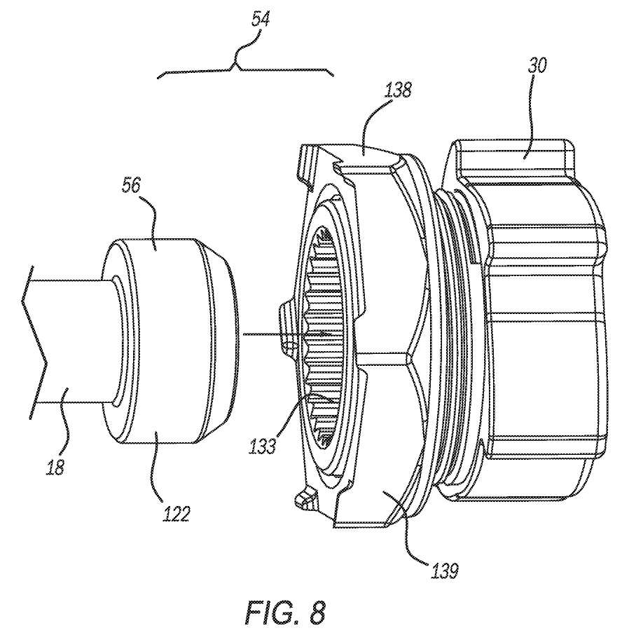

FIGS. 7-9 illustrate a second alternate embodiment of the spool assembly 110B. In this example the interaction between insert 30 and tread head interior cavity 31 is consistent with the prior art example shown in FIG. 1 which provides only a limited number of relative angular assembled conditions. Likewise, first torque transmitting interface 46 formed by torsion bar second end 20 and blind end pocket 24 is also consistent with a prior art configuration. This is an example that it is not necessary to achieve the benefits of the present invention for all of the torque transmitting interfaces to have the infinite adjustment feature previously described. FIG. 8 is an enlargement of the components forming the second torque transmitting interface 54 as shown in FIG. 7.

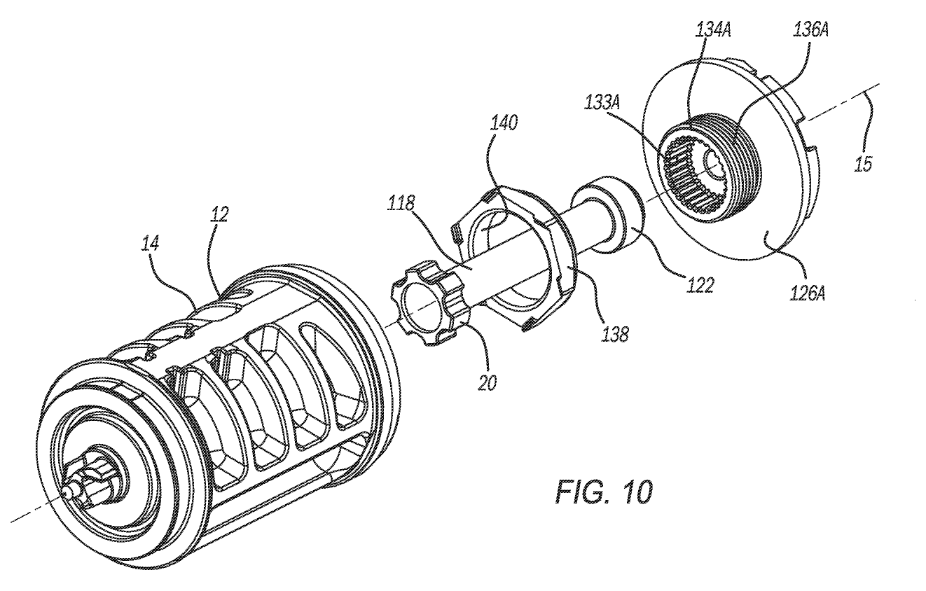

FIG. 10 illustrates a third embodiment of a spool assembly in accordance with the present invention. In this example, a modified version of tread head 126A is illustrated which integrally forms features of insert 130 and tread head 126 previously illustrated as separate components. Here, modified tread head 126A features protruding tubular section 134A and forming external threads 136A and internal surface 133A, and having protruding tubular section 134A in this case featuring splines.

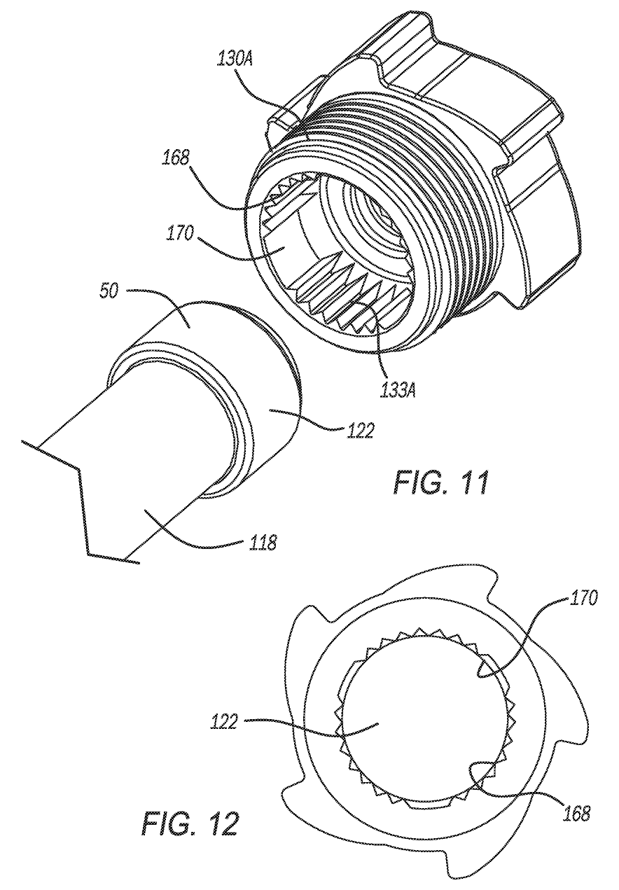

FIG. 11 and 12 illustrated an additional alternate embodiment for the second torque transmitting interface 54. In this example, torsion bar end 122 is consistent with the configuration illustrated in FIG. 3. However, internal surface 133 of insert 130 has a spline configuration which is modified. Here, instead of spline teeth 168 arranged uniformly around the entire inner perimeter of internal surface 133A, they are formed in groups separated by smooth sections 170. FIG. 12 shows a cross-section of this configuration. By reducing the number of inward protrusions formed by teeth 168 a reduced assembly force may be provided while reducing stress on mating components. This configuration combines the previous described smooth and knurled interfacing surface configurations in one part. The number of teeth and the angular extension of smooth portions 170 can be adjusted to provide desired assembly and performance characteristics.

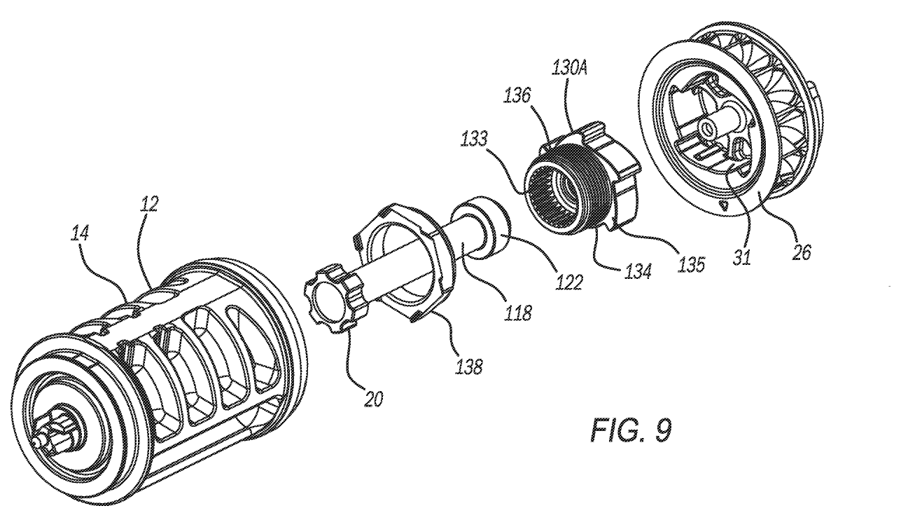

The present invention also encompasses various assembly processes (methods). The components generally in the configuration of the parts in the exploded view FIG. 3 can be compressed together along axis 15. For example, torsion bar first end 120 could be first inserted and press fit into position into spool pocket 124, creating a spool subassembly. A tread head sub-assembly including tread head 126, insert 130 and nut 38 can be pressed together and, as done in the prior art, hex nut 38 can be fully seated to a stop position and then backed off to a predetermined position, or left fully seated. Thereafter, the tread head subassembly and spool subassembly can be set to a desired relative angular position and then pressed together such that the second torque transmitting interface 54 provides the desired infinite angular indexing position desired. The described method utilizes the second torque transmitting interface 54 as the final interaction for providing the desired fine stop setting feature. Many other assembly sequences can be implemented providing the fine stop setting features of the present invention. For example, the components could be assembled leaving components of the first torque transmitting interface 46 or the third torque transmitting interface 60 to be the last interface to be created during assembly once the other components are set to a set relative angular orientation position selected to provide the desired webbing stop position. And further, an assembly sequence is envisioned in which the parts as shown in FIG. 3 are first set to a desired relative angular position and then simultaneously pressed into their final assembled condition in which one or more of the torque transmitting interfaces are created simultaneously during press fit assembly. FIGS. 7 and 9 illustrate configurations in which the sole torque transmitting interface featuring the press fit features of the present invention is provided at interface 54. This configuration would be assembled as described previously in which the spool and tread head subassemblies are previously assembled and then pressed together for final assembly. FIG. 9 illustrates a similar configuration in which only one torque transmitting interface is provided.

While the above description constitutes the preferred embodiment of the present invention, it will be appreciated that the invention is susceptible to modification, variation and change without departing from the proper scope and fair meaning of the accompanying claims.

What is claimed is:

1. A spool assembly for a seat belt retractor for seat belt webbing and providing load limiting and protraction limiting stop functions, comprising;
a spool having an exterior surface for receiving the seat belt webbing, and an interior cavity, the spool forming an internal cavity and an end pocket, and having an open end surface,
a torsion bar received by the spool interior cavity and having first and second ends, the first end received by the spool end pocket and forming a first torque transmitting interface,
a tread head having a rotor and forming a tread head interior cavity,
an insert forming an insert interior cavity receiving the torsion bar second end forming a second torque transmitting interface, an external cylindrical surface received by the tread head interior cavity forming a third torque transmitting interface, and an external threaded surface,
a stop nut having an interior threaded surface threaded onto the insert external threaded surface, the stop nut forming an external torsional coupling surface received by the spool open end surface, and
wherein at least one of the first, the second and the third torque transmitting interface forming an interference fit between the respective components thereby providing an infinite variety of relative angular positions of the components interfacing at the at least one of the first, the second and the third torque transmitting interface.

2. The spool assembly in accordance with claim 1, further comprising; wherein the at least one of the first, the second and the third torque transmitting interface formed by a component forming a smooth cylindrical external surface and a component forming a smooth internal surface wherein the components are joined together by the interference fit.

3. The spool assembly in accordance with claim 1, further comprising; wherein the at least one of the first, the second and the third torque transmitting interface formed by a component forming a knurled cylindrical external surface and a component forming a smooth internal surface wherein the components are joined together by the interference fit.

4. The spool assembly in accordance with claim 1, further comprising; wherein the at least one of the first, the second and the third torque transmitting interface formed by a component forming a smooth cylindrical external surface and a component forming a knurled internal surface wherein the components are joined together by the interference fit.

5. The spool assembly in accordance with claim 1, further comprising; wherein the at least one of the first, the second and the third torque transmitting interface formed by a component forming a smooth cylindrical external surface and a component forming an internal surface having a plurality of groups of teeth separated by segments of smooth surfaces arranged around the internal surface wherein the components are joined together by the interference fit.

6. The spool assembly in accordance with claim 1 further comprising; the first torque transmitting interface formed by the torsion bar first end forming a knurled external surface received by the spool end pocket forming a smooth interior surface.

7. The spool assembly in accordance with claim 1, further comprising; the second torque transmitting interface formed by the torsion bar second end forming a smooth external surface received by the insert interior cavity forming a knurled interior surface.

8. The spool assembly in accordance with claim 1, further comprising; the second torque transmitting interface formed by the torsion bar second end forming a smooth external surface received by the insert interior cavity forming an internal surface having a plurality of groups of teeth separated by segments of smooth surfaces arranged around the internal surface wherein the components are joined together by the interference fit.

9. The spool assembly in accordance with claim 1, further comprising; the third torque transmitting interface formed by the insert external cylindrical surface forming a knurled surface received by the tread head interior cavity forming a smooth internal surface.

10. The spool assembly in accordance with claim 7, further comprising; a spool insert is installed in the spool end pocket and forming teeth which engage with the torsion bar first end formed with a smooth exterior surface to provide the first torque transmitting interface.

11. The spool assembly in accordance with claim 1, further comprising; wherein the first torque transmitting interface is formed by the torsion bar first end forming a toothed outer surface received by the spool end pocket in a number of discrete relative angular positions.

12. The spool assembly in accordance with claim 1, further comprising; wherein the third torque transmitting interface is formed by the insert external cylindrical surface forming a toothed outer surface received by the tread head interior cavity in a number of discrete relative angular positions.

13. The spool assembly in accordance with claim 1, further comprising; the stop nut advances along the insert external threaded surface upon a torsional deflection of the torsion bar until the stop nut reaches a stop position whereby the infinite variety of relative angular positions of the components interfacing at the at least one of the first, the second and the third torque transmitting interface enables a webbing extension stop position of the webbing to be established when the stop nut reaches the stop position.

14. A spool assembly for a seat belt retractor for seat belt webbing and providing load limiting and protraction limiting stop functions, comprising;
a spool having an exterior surface for receiving the seat belt webbing, and an interior cavity, the spool forming an internal cavity and an end pocket, and having an open end surface,
a torsion bar received by the spool interior cavity and having first and second ends, the first end received by the spool end,
a tread head having a rotor and forming a tread head interior cavity receiving the torsion bar second end thereby forming a torque transmitting interface and forming an external threaded surface,
a stop nut having an interior threaded surface threaded onto the tread head external threaded surface, the stop nut forming an external torsional coupling surface received by the spool open end surface, and
wherein the torque transmitting interface forming an interference fit between the torsion bar and the tread head thereby providing an infinite variety of relative angular positions of the torsion bar and thread head at the torque transmitting interface.

15. The spool assembly in accordance with claim 14, further comprising; the torque transmitting interface formed by the torsion bar second end forming a smooth external surface received by the tread head interior cavity forming a knurled interior surface.

16. The spool assembly in accordance with claim 14, further comprising; the torque transmitting interface formed by the torsion bar second end forming a smooth external surface received by the tread head interior cavity forming an internal surface having a plurality of groups of teeth separated by segments of smooth surfaces arranged around the internal surface wherein the components are joined together by the interference fit.

17. A method of assembling a spool assembly for a seat belt retractor for seat belt webbing and providing load limiting and protraction limiting stop functions, comprising the steps of;
providing a spool having an exterior surface for receiving the seat belt webbing, and an interior cavity, the spool forming an internal cavity and an end pocket, and having an open end surface,
providing a torsion bar received by the spool interior cavity and having first and second ends, the first end received by the spool end pocket and forming a first torque transmitting interface,
providing a tread head or an insert wherein the tread head or the insert forming an interior cavity receiving the torsion bar second end forming a second torque transmitting interface,
providing a stop nut having an interior threaded surface threaded onto the insert external threaded surface, the stop nut forming an external torsional coupling surface received by the spool open end surface, and
wherein at least one of the first and the second torque transmitting interface forming an interference fit between the respective components thereby providing an infinite variety of relative angular positions of the components interfacing at the at least one of the first and the second torque transmitting interface,
orienting components forming at least one of the first and the second torque transmitting interface in a desired relative rotationally indexed position, and
pressing together the components to create the interference fit and to provide the interference fit.

18. A method of assembling a spool assembly for a seat belt retractor in accordance with claim 17, further comprising the step of providing the tread head having a rotor and forming a tread head interior cavity and providing the insert forming an external cylindrical surface received by the tread head interior cavity forming a third torque transmitting interface In wherein at least one of the first, the second and the third torque transmitting interfaces forming the interference fit.

19. The method of assembling a spool assembly in accordance with claim 17, further comprising wherein the stop nut advances along the external threaded surface upon a torsional deflection of the torsion bar until the stop nut reaches a stop position whereby the infinite variety of relative angular positions of the components interfacing at the at least one of the first and the second torque transmitting interface enables a webbing extension stop position of the webbing to be established when the stop nut reaches the stop position and wherein the desired relative angular position is selected to provide the extension stop position.
